(19) United States
(12) Patent Application Publication
(10) Pub. No.: US 2008/0139868 A1
(43) Pub. Date: Jun. 12, 2008

(54) Method for optimal stabilization of incinerator ash by combined acidulation and stabilization

(76) Inventor: Keith Edward Forrester, Meredith, NH (US)

Correspondence Address: Keith E. Forrester, 78 Tracy Way, Meredith, NH, 03253, US

(21) Appl. No.: 11/975,438

(22) Filed: Oct. 19, 2007

Related U.S. Application Data
(60) Provisional application No. 60/854,032, filed on Oct. 24, 2006.

(51) Int. Cl. B09B 3/00

(52) U.S. Cl. 588/256

(57) ABSTRACT

This invention provides a method for optimal stabilization of incinerator ash subject to acid and water leaching tests or leach conditions by addition of a combined acidulation and stabilization agent, such that the acidulated and stabilized ash requires TCLP Fluid #1 and the leaching of lead and cadmium is controlled to desired levels. The resultant ash after stabilization is suitable for disposal as RCRA non-hazardous waste.

### BACKGROUND OF THE INVENTION

Heavy metal bearing combined ash (bottom ash mixed with flyash and scrubber residue), bottom ash from furnace grates, and air pollution unit collected flyash and air pollution control unit generated scrubber residue combinations from mass burn refuse incinerators and refuse derived fuel incinerators may be deemed “Hazardous Waste” by the United States Environmental Protection Agency (USEPA) pursuant to 40 C.F.R. Part 261 and also deemed hazardous under similar regulations in other countries such as Japan, Switzerland, Philippines, Germany, United Kingdom, Mexico, Australia, Canada, Taiwan, European Countries, India, and China, and deemed special waste within specific regions or states within those countries, if containing designated leachate solution-soluble and/or sub-micron filter-passing particle sized lead (Pb) and cadmium (Cd) above levels deemed hazardous by those country, regional or state regulators.

Scrubber residue is most commonly a high calcium lime-based solid dry powder waste produced from the interaction between either dry lime hydrate as CaO×10H2O or slurry lime and emission acid gas components such as sulfur oxides and hydrochloric acid derived from the combustion of refuse fuels, which are regulated under the Clean Air Act and Amendments thereto. Some scrubbers referred to as “dry lime scrubbers” operate by injecting a fine-powder dry calcium hydrated quicklime as [CaO×10H2O] prior to a baghouse collection unit, which produces significant excess stoichiometric lime in the scrubber residue due to incomplete lime conversion to salts by acid gas contact. Most modern incinerator scrubbers use a wet slurry of quicklime [CaO], where dry quicklime is hydrated on-site in slaking units and the subsequent slurry is injected into a spray tower which provides for a very efficient lime consumption and lower lime excess remaining in the scrubber residue ash stream. Another less common acid gas scrubbing method uses sodium carbonate, which provides for a different molecular conversion of acid gas products from combustion. Both lime scrubber and carbonate scrubber technologies produce particulate solids from the reaction between reagent and acid gases, which are subsequently captured by either cyclones or baghouse fabric collectors downstream of the scrubber.

Most lime scrubbers at refuse mass burn or refuse derived fuel incinerators have been tuned by operators to produce excess calcium lime for the purpose of controlling spikes in acid gases from the combustion unit and also for providing a high calcium based pH combined ash which would routinely require Extraction Fluid #2 and produce a final pH of an 18 hour extract fluid of above about 8.5 units as measured under the RCRA Toxicity Characteristic Leaching Procedure (TCLP). The TCLP test procedure (USEPA Method 1311) uses a fluid determination step first to define which TCLP fluid is used for the subject waste extraction . . . either TCLP fluid 1 for less alkaline wastes and TCLP fluid 2 for more alkaline wastes such as excess lime scrubber residues and ashes combined with such lime wastes. The TCLP “fluid determination” step is defined within USEPA Method 1311 and required under 40 CFR Part 261.24. Both Pb and Cd hydroxides exhibit relatively low solubility under the TCLP test if the combined ash pH under TCLP at 18 hours of extraction is measured at about 8.5 units to 10.5 units. Both Cd and Pb solubility become higher below 8.5 pH units, and Pb above pH 10.5 becomes more soluble, which exhibits the classic lead “amphoteric” leaching behavior. Consequently, combustion facility operators choose to produce an ash which is alkaline requiring TCLP Fluid #2 and that will generate a high pH to offset the acetic acid added during the TCLP Fluid #2 test and result in a final extract pH from about 8.5 to 10.5 units. The TCLP Fluid #2 leachate has a initial pH of 2.89, which is quickly increased to above 8.5 in an alkaline waste mix such as high lime containing incinerator ash.

In the United States, any industrial solid waste such as incinerator combined ash or flyash and scrubber residue can be defined as Hazardous Waste either because it is “listed” in 40 C.F.R., Part 261 Subpart D, federal regulations adopted pursuant to the Resource Conservation and Recovery Act (RCRA), or because it exhibits one or more of the characteristics of a Hazardous Waste as defined in 40 C.F.R. Part 261, Subpart C. The hazard characteristics defined under 40 CFR Part 261 are: (1) ignitability, (2) corrosivity, (3) reactivity, and (4) toxicity as tested under the Toxicity Characteristic Leaching Procedure (TCLP). 40 C.F.R., Part 261.24(a), contains a list of heavy metals and their associated maximum allowable concentrations. If a heavy metal, such as lead, exceeds its maximum allowable concentration from a solid waste, when tested using the TCLP analysis as specified at 40 C.F.R. Part 261 Appendix 2, then the solid waste is classified as RCRA Hazardous Waste. The USEPA TCLP test uses a dilute acetic acid either in de-ionized water (TCLP fluid 2) or in de-ionized water with a sodium hydroxide buffer (TCLP fluid 1). Both extract methods attempt to simulate the leachate character from a decomposing trash landfill in which the solid waste being tested for is assumed to be disposed in and thus subject to rainwater and decomposing organic matter leachate combination . . . or an acetic acid leaching condition. Waste containing leachable heavy metals is currently classified as hazardous waste due to the toxicity characteristic, if the level of TCLP analysis is above 0.2 to 100 milligrams per liter (mg/L) or parts per millions (ppm) for specific heavy metals. The TCLP test is designed to simulate a worst-case leaching situation . . . that is a leaching environment typically found in the interior of an actively degrading municipal landfill. Such landfills normally are slightly acidic with a pH of approximately 5±0.5.

Countries outside of the US also use the TCLP test as a measure of leaching such as Thailand, Philippines, China, Taiwan, and Canada. Thailand also limits solubility of Cu and Zn, as these are metals of concern to Thailand groundwater. Switzerland, Mexico, Europe and Japan regulate management of solid wastes by measuring heavy metals and salts as tested by a sequential leaching method using carbonated water simulating rainwater, synthetic rainwater and de-ionized water sequential testing. Additionally, U.S. EPA land disposal restrictions prohibit the land disposal of solid waste leaching in excess of maximum allowable concentrations upon performance of the TCLP analysis. The land disposal regulations require that hazardous wastes are treated until the heavy metals do not leach at levels from the solid waste at levels above the maximum allowable concentrations prior to placement in a surface impoundment, waste pile, landfill or other land disposal unit as defined in 40 C.F.R. 260.10.

Suitable acetic acid leach tests include the USEPA SW-846 Manual described Toxicity Characteristic Leaching Procedure (TCLP) and Extraction Procedure Toxicity Test (EP Tox) now used in Canada. Briefly, in a TCLP test, 100 grams of waste are tumbled with 2000 ml of dilute and buffered or non-buffered acetic acid for 18 hours and then filtered through a 0.75 micron filter prior to nitric acid digestion and final ICP analyses for total “soluble” metals. The extract solution is made up from 5.7 ml of glacial acetic acid and 64.3 ml of 1.0 normal sodium hydroxide up to 1000 ml dilution with reagent water.

Suitable water leach tests include the Japanese leach test which tumbles 50 grams of composited waste sample in 500 ml of water for 6 hours held at pH 5.8 to 6.3, followed by centrifuge and 0.45 micron filtration prior to analyses. Another suitable distilled water CO₂ saturated method is the Swiss protocol using 100 grams of cemented waste at 1 cm³ in two (2) sequential water baths of 2000 ml. The concentration of lead and salts are measured for each bath and averaged together before comparison to the Swiss criteria.

Suitable citric acid leach tests include the California Waste Extraction Test (WET), which is described in Title 22, Section 66700, “Environmental Health” of the California Health & Safety Code. Briefly, in a WET test, 50 grams of waste are tumbled in a 1000 ml tumbler with 500 grams of sodium citrate solution for a period of 48 hours. The concentration of leached lead is then analyzed by Inductively-Coupled Plasma (ICP) after filtration of a 100 ml aliquot from the tumbler through a 45 micron glass bead filter.

The present invention provides a method of reducing the TCLP measured solubility of Pb and Cd bearing incinerator ash which includes lime acid gas scrubbing technology or sodium carbonate scrubbing technology, by incorporating addition of a combined acidulation and stabilization agent as a means of producing a stabilized and acidulated ash which requires TCLP Fluid one (1) while also generating a TCLP extract fluid pH at 18 hours of extraction that allows Pb and Cd to remain below hazardous waste leaching limits of 5.0 ppm and 1.0 ppm respectively. Pb and Cd are controlled by the invention under TCLP, SPLP, CALWET, MEP, rainwater and surface water leaching conditions as well as under regulatory water extraction test conditions as defined by waste control regulations in Thailand, Taiwan, Japan, Canada, UK, Mexico, Switzerland, Germany, Sweden, The Netherlands and under American Nuclear Standards for sequential leaching of wastes by de-ionized water. Unlike the present invention, current ash stabilization practice has focused on reducing solubility of Pb and Cd in ash residues by introduction of excess calcium oxide through the acid gas scrubber and producing a TCLP Fluid 2 tested waste, or addition of phosphoric acid stabilizer at dosage level which holds the ash alkalinity high enough to require TCLP fluid #2, without consideration of controlled stabilization and acidulation of the ash to produce a TCLP Fluid 1 leaching environment while also regulating the amount of acidulation to generate a Fluid #1 extract pH level where Cd and Pb are leaching level below hazardous waste limits.

U.S. Pat. No. 5,202,033 describes an in-situ method for decreasing Pb TCLP leaching from solid waste using a combination of solid waste additives and additional pH controlling agents from the source of phosphate, carbonate, and sulfates.

U.S. Pat. No. 5,037,479 discloses a method for treating highly hazardous waste containing unacceptable levels of TCLP Pb such as lead by mixing the solid waste with a buffering agent selected from the group consisting of magnesium oxide, magnesium hydroxide, reactive calcium carbonates and reactive magnesium carbonates with an additional agent which is either an acid or salt containing an anion from the group consisting of Triple Superphosphate (TSP), ammonium phosphate, diammonium phosphate, phosphoric acid, boric acid and metallic iron.

U.S. Pat. No. 4,889,640 discloses a method and mixture from treating TCLP hazardous lead by mixing the solid waste with an agent selected from the group consisting of reactive calcium carbonate, reactive magnesium carbonate and reactive calcium magnesium carbonate.

U.S. Pat. No. 4,652,381 discloses a process for treating industrial wastewater contaminated with battery plant waste, such as sulfuric acid and heavy metals by treating the waste waster with calcium carbonate, calcium sulfate, calcium hydroxide to complete a separation of the heavy metals. However, this is not for use in a solid waste situation.

### SUMMARY OF THE INVENTION

The present invention discloses a Pb and Cd bearing refuse incinerator combined ash, bottom ash or flyash and scrubber residue combination stabilization and acidulation method through contact of combined ash, bottom ash or flyash and scrubber residue with acidulation and stabilization agents including acids, triple super phosphate, merchant grade phosphoric acid, phosphoric acid, co-product from aluminum finishing, sulfuric acid, hydrochloric acid, and combinations thereof which are properly chosen to result in an ash TCLP Fluid determination of Fluid One (1) as defined under USEPA Method 1311, while maintaining sufficient pH in the TCLP Fluid 118 hour extractor and sufficient Pb and Cd stabilization agent content in the ash to produce Pb and Cd non-hazardous leaching levels.

It is anticipated that the acidulation and stabilization method can be used for both reactive compliance and remedial actions as well as proactive leaching reduction means such that generated ash does not exceed hazardous waste criteria. The preferred method of application of acidulation and stabilization agents would be in-line within the ash collection units and after the scrubber operation, and thus eliminating the need for expensive ash conditioning or mixing equipment and also allowed under USEPA regulations (RCRA) as totally enclosed, in-line exempt method of TCLP stabilization without the need for a RCRA Part B hazardous waste treatment and storage facility permit.

### DETAILED DESCRIPTION

Environmental regulations throughout the world such as those developed by the USEPA under RCRA and CERCLA require heavy metal bearing waste and material producers to manage such materials and wastes in a manner safe to the environment and protective of human health. In response to these regulations, environmental engineers and scientists have developed numerous means to control heavy metals, mostly through chemical applications which convert the solubility of the material and waste character to a less soluble form, thus passing leach tests and allowing the wastes to be either reused on-site or disposed at local landfills without further and more expensive control means such as hazardous waste disposal landfills or facilities designed to provide metals stabilization. The primary focus of scientists has been on reducing solubility of heavy metals such as lead, cadmium, chromium, arsenic and mercury, as these were and continue to be the most significant mass of metals contamination in our environment.

Scrubber residue from refuse incinerators is most commonly a calcium lime-based solid product produced from the interaction between either dry or slurry lime as CaOH or CaOH(x) and acid gas components derived from the combustion of refuse which generate gases as sulfur dioxides and hydrogen chlorides regulated under the Clean Air Act and Amendments thereto. Some scrubbers referred to as dry lime scrubbers operate by injecting a fine-powder dry hydrated calcium quicklime prior to a baghouse collection unit. Most scrubbers use a wet slurry calcium quicklime, hydrated on-site in mixing units and injected into a spray tower which provides for a very efficient lime consumption and low lime excess remaining in the scrubber residue stream.

Both scrubber methods used at incinerators are operated with excess lime to control spikes in acid gas emissions and produce excess lime within the scrubber residue for the purpose of stabilizing the facility combined ash Pb and Cd as tested under RCRA TCLP Fluid #2. Both Pb and Cd minerals have low solubility under TCLP testing if the combined ash final pH within the TCLP extractor are held at about 9.5 units to 10.5 units. Both Cd and Pb solubility become higher below 8.5 pH units, and Pb above pH 10.5 becomes more soluble, which exhibits “amphoteric” Pb leaching behavior.

There exists a demand for improved TCLP control methods of lead and cadmium from incinerator combined ash, bottom ash, flyash and scrubber residues. The present invention discloses a Pb and Cd bearing incinerator combined ash, bottom ash or flyash and scrubber residue combination stabilization and acidulation method through contact of combined ash, bottom ash or flyash and scrubber residue with acidulation and stabilizing agents including acids, triple super phosphate, phosphoric acids, merchant grade phosphoric acids, coproduct from aluminum anodizing, sulfuric acid, hydrochloric acid, technical grade phosphoric acids, and combinations thereof which are properly chosen to produce an ash which requires TCLP Fluid #1 and maintains the pH of the TCLP 18 hour extraction Fluid #1 at a range where lead and cadmium minerals found within the incinerator ash are held at level less than hazardous or regulated levels, regardless of mineral form. In order to require a TCLP Fluid #1 extract fluid determination, the acidulated and stabilized ash must generate a test solution pH of less than 5.0 after 5 grams of stabilized and acidulated ash are stirred with 96.5 ml of DI H2O for 5 minutes and 3.5 ml of 1.0 Normal HCL solution are added and heated to at 50 degree C. for 10 minutes.

It is anticipated that the acidulation and stabilization method can be used for both reactive compliance and remedial actions as well as proactive leaching reduction means such that generated ash and residue does not exceed hazardous waste criteria. The preferred method of application of acidulation and stabilization agents would be in-line within the ash and residue collection units and after the scrubber operation, and thus eliminating the need for expensive ash conditioning or mixing equipment and also allowed under USEPA regulations (RCRA) as totally enclosed, in-line exempt method of TCLP stabilization without the need for a RCRA Part B hazardous waste treatment and storage facility permit.

The acidulation and stabilizing agents for Pb and Cd bearing refuse incinerator combined ash, bottom ash or flyash and scrubber residue combination including acids, triple super phosphate, merchant grade phosphoric acid, phosphoric acid, co-product from aluminum anodizing, sulfuric acid, hydrochloric acid, and combinations thereof would be selected through laboratory treatability and/or bench scale testing to provide sufficient control of Pb and Cd solubility to non-hazardous levels. The acidulation agent type, dose rate, contact duration, and application means would be engineered for each type of ash and scrubber residue production facility. Although the exact acidulation and stabilization formation minerals are undetermined at this time, it is expected that when lead or cadmium comes into contact with the acidulation and stabilization agent, low extract fluid soluble minerals form such as a lead and cadmium apatites, metals sulfates, and metal phosphates which have a low solubility under TCLP Fluid #1 extract fluid pH above 5.0.
The optimum TCLP Fluid #1 leaching test 18 hour extract fluid pH for obtaining the lowest lead and cadmium solubility under this acidulation and stabilization method will vary from incinerator ash and scrubber residue type and production, although anticipated to range from a final TCLP extract pH of 8.5 to 10.5 units. As leach tests used throughout the world also vary as to extractor size, sample size, tumbling method, extract fluid (i.e., water, acetic acid, citric acid, synthetic rainwater, carbonated water, distilled water), the optimum pH range will be obtained through varying degrees of acidulation and stabilization agent dose. One skilled in the art of laboratory treatability studies will be able to develop two-dimensional dose-response relationships for a specific ash and residue combination and specific leaching method, and thus determine the best cost means of stabilization and acidulation agent combination.

Examples of suitable acidulation and stabilizing agents include, but are not limited to acids, acidulated monocalcium phosphate (Triple Super Phosphate), merchant grade phosphoric acid, phosphoric acid, co-product from aluminum finishing, sulfuric acid, hydrochloric acid, and combinations thereof which are properly chosen to result in an ash TCLP Fluid determination of Fluid 1 as defined under USEPA Method 1311, while maintaining sufficient pH during the TCLP Fluid 1 extraction and stabilizer to produce Pb and Cd non-hazardous leaching levels. The amounts of acidulation and stabilization agent used, according to the method of invention, depend on various factors including desired solubility reduction potential, leaching test method, desired mineral toxicity, and desired mineral formation relating to toxicological and site environmental control objectives. It has been found that addition of 3% Triple Super Phosphate by weight of combined ash was sufficient for TCLP Pb and TCLP Cd stabilization to less than RCRA 5.0 ppm and 1.0 ppm limits while also producing a acidulated and stabilized ash which produced a pH of less than 5.0 under the TCLP fluid determination step and hence was extracted under TCLP Fluid #1. However, the foregoing is not intended to preclude yet higher or lower usage of acidulation and stabilization agents.

The examples below are merely illustrative of this invention and are not intended to limit it thereby in any way.

### EXAMPLE 1

Combined ash from a mass-burn refuse incinerator in Hampton, Va., fitted with a wet calcium hydrate scrubber, was stabilized with varying amounts of combined acidulation and stabilization agents as: merchant grade phosphoric acid (H3PO4), dicalcium phosphate (DCP), high calcium content calcined lime (CaO), and monocalcium phosphate as Triple Super Phosphate (GTSP) and tested for TCLP fluid determination and 18 hour extract Pb and Cd leaching levels. The mixed acidulation and stabilized sample was not allowed to cure and was subjected to TCLP analyses Method 1311 and extract digestion by EPA method 200.7.

TABLE 1

| | TCLP Pb/Cd | Fluid pH | |
|---|---|---|---|
| Addition Dosage | (ppm) | (18 hr) | TCLP Fluid |
| Baseline | 12/1.6 | 4.8 | 2 (Required) |
| Baseline | <0.001/0.002 | 9.6 | 1 (Test Only) |
| 1% GTSP | 0.68/2.4 | 4.8 | 2 (Required) |
| 1% GTSP | <0.001/<0.001 | 9.5 | 1 (Test Only) |
| 2% GTSP | 0.22/1.4 | 4.7 | 2 (Required) |
| 2% GTSP | <0.001/<0.001 | 9.4 | 1 (Test Only) |
| 3% GTSP | <0.001/<0.001 | 9.4 | 1 (Required) |
| 3% H3PO4 | 2.67/0.87 | 5.1 | 1 (Required) |
| 3% DCP | 7.1/2.2 | 4.7 | 2 (Required) |
| 10% CaO | 3.4/<0.001 | 11.6 | 2 (Required) |

The foregoing results in Example 1 readily established the operability of the present process to produce a TCLP Fluid #1 ash while also stabilizing lead and cadmium bearing combined ash thus reducing leachability to less than the regulatory limits. Table I also presents Triple Super Phosphate as the best and preferred method of stabilization and acidulation, as the TSP acidulation effect is less potent as compared to acid as H3PO4 and TSP addition results in a superior 9.4 pH extract fluid 1 end-point which produces far lower Pb and Cd leaching levels at less cost and with less materials handling problems as encountered with acids. Table I also presents that the fluid determination and final extract pH levels of a given recipe will have significant impact on the Pb and Cd leaching levels, and that a recipe designed for ash stabilization and acidulation at TCLP fluid one (1) and pH extract levels about between 8.5 and 10.5 units will have lowest Pb and Cd leaching levels. It is believed that an amount of the acidulation and stabilization agent as TSP of equivalent to less than 3% by weight of ash should be effective.

While this invention has been particularly shown and described with reference to preferred embodiments thereof, it will be understood by those skilled in the art that various changes in form and details may be made therein without departing from the spirit and scope of the invention as defined by the appended claims.

I claim:

1. A method of reducing the solubility of lead and cadmium bearing ash, comprising contacting ash with at least one acidulation and stabilization agent in an amount effective in reducing the leaching of lead and cadmium from the ash to a level no more than non-hazardous levels as determined under the USEPA RCRA TCLP test, performed on the stabilized and acidulated ash composite samples, as set forth in the Federal Register, vol. 55, no. 126, pp. 26985-26998 (Jun. 29, 1990).

2. The method of claim 1, wherein the acidulation and stabilization agent is selected from the group consisting of acids, acidulated monocalcium phosphate (Triple Super Phosphate), merchant grade phosphoric acid, phosphoric acid, co-product from aluminum finishing, sulfuric acid, hydrochloric acid, and combinations thereof which are properly chosen to result in an ash TCLP Fluid determination of Fluid 1 as defined under USEPA Method 1311, while maintaining sufficient pH during the TCLP Fluid 1 extraction and stabilizer content to produce Pb and Cd non-hazardous leaching levels.

3. A method of claim 1 wherein reduction of solubility is to a level no more than non-hazardous levels as determined under leach tests required by regulation in countries other than the USA using TCLP including but not limited to Switzerland, Mexico, Japan, Thailand, Canada, Germany, India, Africa, South America, and all European Block Countries.

4. A method of claim 1 wherein the ash is refuse mass burn or refuse derived fuel incinerator flyash, scrubber residue, bottom ash, combined ash, and combinations thereof.

5. A method of reducing the solubility of lead and cadmium bearing ash residue, comprising contacting ash with at least one acidulation and stabilization agent in an amount effective in reducing the leaching of lead and cadmium from the ash mixture to a level no more than non-hazardous levels by generating a TCLP Fluid 1 determination and 18-hour extract pH level of between 8.5 and 10.5 units as determined in an EPA TCLP Fluid 1 test, performed on the stabilized material or waste, as set forth in the Federal Register, vol. 55, no. 126, pp. 26985-26998 (Jun. 29, 1990).

6. The method of claim 5, wherein the pH increasing agent is selected from the group consisting of acids, acidulated monocalcium phosphate (Triple Super Phosphate), merchant grade phosphoric acid, phosphoric acid, co-product from aluminum finishing, sulfuric acid, hydrochloric acid, and combinations thereof which are properly chosen to result in an ash TCLP Fluid determination of Fluid 1 as defined under USEPA Method 1311, while maintaining sufficient pH during the TCLP Fluid 1 extraction and stabilizer to produce Pb and Cd non-hazardous leaching levels.

7. A method of claim 1 wherein reduction of solubility is to a level no more than non-hazardous levels as determined under leach tests required by regulation in countries other than the USA using TCLP including but not limited to Switzerland, Mexico, Japan, Thailand, Canada, Germany, India, Africa, South America, and all European Block Countries.

8. A method of claim 1 wherein the ash is refuse mass burn or refuse derived fuel incinerator flyash, scrubber residue, bottom ash, combined ash, and combinations thereof.
